(19) United States
(12) Patent Application Publication
(10) Pub. No.: US 2006/0034385 A1
(43) Pub. Date: Feb. 16, 2006

(54) Wireless communication apparatus and method for estimating number of antennas

(76) Inventors: Yoshimasa Egashira, Kawasaki-shi (JP); Daisuke Takeda, Kawasaki-shi (JP); Yasuhiko Tanabe, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/200,122

(22) Filed: Aug. 10, 2005

(30) Foreign Application Priority Data
Aug. 11, 2004 (JP) 2004-234631

(51) Int. Cl. H04L 1/02

(52) U.S. Cl. 375/267; 375/299; 375/347

(57) ABSTRACT

wireless communication apparatus (transmitter) including a plurality of antennas for transmitting a plurality of known symbol sequences and data symbols, transmits the known symbol sequences, each of the known symbol sequences including a plurality of known symbols, each of the known symbols whose plural known information being carried on a plurality of subcarriers, a phase of last known symbol of the each of the known symbol sequences being rotated, and transmits the data symbols after the known symbol sequences are transmitted.

### CROSS-REFERENCE TO RELATED APPLICATIONS

This application is based upon and claims the benefit of priority from prior Japanese Patent Application No. 2004-234631, filed Aug. 11, 2004, the entire contents of which are incorporated herein by reference.

### BACKGROUND OF THE INVENTION

1. Field of the Invention

The present invention relates to a MIMO-OFDM technique of performing communication by using a plurality of antennas and a plurality of subcarriers and, more particularly, to a high-speed wireless LAN technique.

2. Description of the Related Art

In a conventional wireless LAN (802.11a), known symbols (short and long preambles) are transmitted before data signals to perform synchronization processing and channel estimation, and the data portions can be demodulated by using these preambles. On the other hand, as a technique of increasing transmission rate without increasing frequency bandwidth, multi-input multi-output (MIMO) is known. In MIMO, a transmitting/receiving unit uses a plurality of antennas. Therefore, when MIMO is applied to a conventional wireless LAN, the arrangements of short and long preambles must be changed to those for MIMO.

According to the preamble proposal proposed by Jan Boer et al. (“Backwards compatibility”, [online], September 2003, IEEE LMSC (publisher), [searched in Sep. 15, 2003], Internet <URL: ftp://ieee:wireless@ftp.802wirelessworld.com/11/03/11-03-0714-00-000n-backwards-compatibility.ppt>), after a short preamble used for time synchronization, frequency synchronization, and AGC, a long preamble containing a symbol for channel response estimation, and a signal field are transmitted from one transmitting antenna, a long preamble for channel response estimation is transmitted from the other transmitting antenna. After the preambles and signal field are transmitted in this manner, data are simultaneously transmitted from a plurality of transmitting antennas. That is, long preambles for channel response are transmitted from a plurality of transmitting antennas by time division multiplexing.

In a MIMO system, in order to demodulate a reception signal, the information of the number of antennas needs to be known on the receiving side. As a method of knowing the number of antennas on the receiving side, a scheme of transmitting a dedicated signal for the notification of this information may be used. This method, however, increases the overhead, and hence the throughput of data transmission decreases. In the case that the number of transmitting antennas is estimated from a reception signal, since an estimation failure makes it impossible to demodulate the signal, high accuracy is required for estimation. There is also conceivable a scheme of estimating the number of transmitting antennas by using a received preamble signal. However, since the preamble signal described in the Jan Boer et al. is not designed to estimate the number of transmitting antennas, it is difficult to perform high-accuracy estimation by using this preamble signal.

As described above, in the MIMO system, when the information of the number of transmitting antennas which is required for demodulation is estimated from a reception signal, the accuracy of estimation is required to be higher than that of data demodulation. It is difficult to perform high-accuracy estimation by using the preamble signal described in the Jan Boer et al. On the other hand, the scheme of transmitting information required for demodulation inevitably increases the overhead.

The present invention has been made in consideration of the above problems, and has as its object to allow the receiving side to easily estimate the number of antennas used for transmission without adding any dedicated signal for the notification of the number of transmitting antennas and properly demodulate a data symbol.

### BRIEF SUMMARY OF THE INVENTION

According to embodiments of the present invention, a wireless communication apparatus (transmitter) including a plurality of antennas for transmitting a plurality of known symbol sequences and data symbols, transmits the known symbol sequences, each of the known symbol sequences including a plurality of known symbols, each of the known symbols whose plural known information being carried on a plurality of subcarriers, a phase of last known symbol of the each of the known symbol sequences being rotated; and transmits the data symbols after the known symbol sequences are transmitted.

A wireless communication apparatus (receiver) receives each of a plurality of known symbols included in each of known symbol sequences which are transmitted by a plurality of antennas of a transmitter, the each of the known symbols whose plural known information being carried on a plurality of subcarriers, a phase of last known symbols of the each of the known symbol sequences being rotated; receives data symbols after the known symbol sequences; calculates a channel estimation value from each of the known symbol received; counts the number of known symbols received; calculates a correlation value between two temporally adjacent known symbols received; estimates the number of antennas based on the correlation value and the counted number of the known symbols received counted; and reproduces the data symbols by using the channel estimation value and the estimated number of antennas.

### BRIEF DESCRIPTION OF THE SEVERAL VIEWS OF THE DRAWING

FIG. 1 is a block diagram showing an example of the arrangement of a transmitter;

FIG. 2 is a view for explaining a method of transmitting known symbols when two transmitting antennas are used;

FIG. 3 is a view for explaining a method of transmitting known symbols when three transmitting antennas are used;

FIG. 4 is a view for explaining a method of transmitting known symbols when four transmitting antennas are used;

FIG. 5 is a block diagram showing an example of the arrangement of a receiver;

FIG. 6 is a flowchart for explaining a process for estimating the number of transmitting antennas in the receiver shown in FIG. 5; and

FIG. 7 is a view showing an example of a table showing the patterns of the respective known symbols (known symbol patterns) transmitted from the respective transmitting antennas.

### DETAILED DESCRIPTION OF THE INVENTION

An embodiment of the present invention will be described below with reference to the views of the accompanying drawing.

A wireless communication system according to the embodiment can be applied to, e.g., a wireless LAN or mobile communication system (cellular system) which includes at least one base station apparatus and at least one terminal apparatus. A transmitter and receiver included in a wireless communication apparatus such as a base station apparatus or terminal apparatus will be described below.

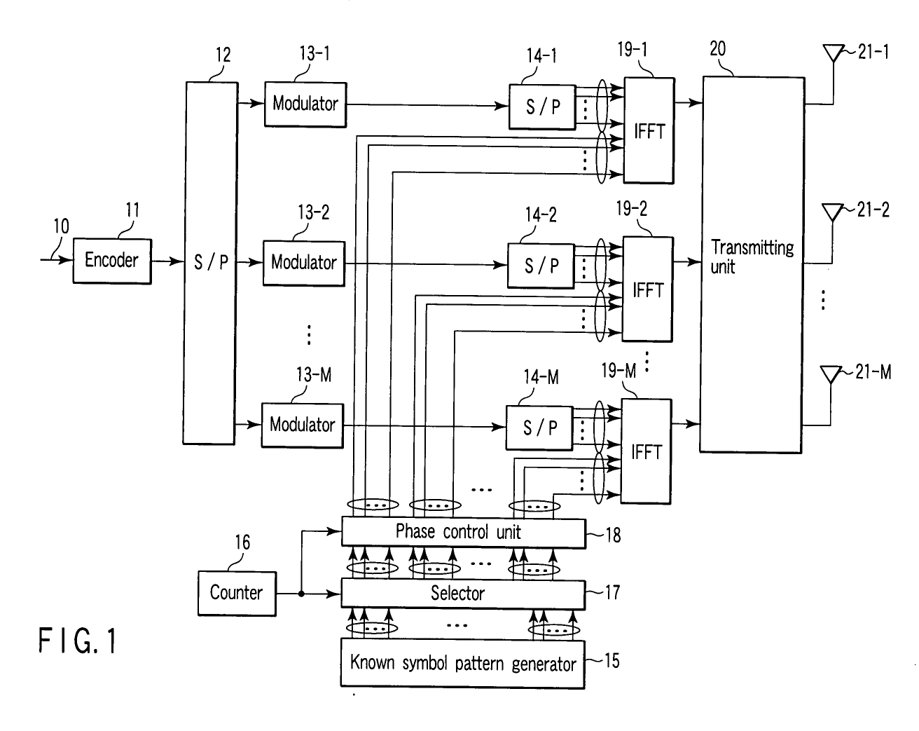

The transmitter according to this embodiment will be described first with reference to FIG. 1. FIG. 1 shows the physical layer of the transmitter, to which data (bit sequence) 10 to be transmitted from an upper layer is input for each transmission unit (e.g., each frame or packet). For example, an encoder 11 error-correction-encodes the input data 10 to generate an encoded bit sequence. A serial/parallel (S/P) 12 serial/parallel-converts the encoded bit sequence into a plurality of streams. Modulators 13-1 to 13-M map the respective streams on complex planes to generate modulated data symbols.

The modulated data symbols are serial/parallel-converted by serial/parallel converters (S/Ps) 14-1 to 14-M to be transmitted on orthogonal frequency division multiplex (OFDM) subcarriers, respectively, and are further converted from the signal in the frequency domain into wave forms in the time domain by inverse fast Fourier transform (IFFT) units 19-1 to 19-M. The signals converted into the wave forms in the time domain are output from the IFFT units 19-1 to 19-M and input to a transmitting unit 20.

In the transmitting unit 20, the output signals from the IFFT units 19-1 to 19-M are converted into analog signals by digital to analog (D/A) converters after guard intervals (GIs) are added to the signals. The output signals from the D/A converters are frequency-converted (up-converted) into signals in the radio frequency (RF) band by frequency converters. The converted signals are then supplied to transmitting antennas 21-1 to 21-M through power amplifiers. As a consequence, the OFDM signals are transmitted from the transmitting antennas 21-1 to 21-M to a wireless communication apparatus as a communication partner.

Before data symbols are transmitted as OFDM signals in this manner, preambles are transmitted. A transmission system for preambles, more specifically, known symbols for channel estimation will be described below.

A known symbol pattern generator 15 is, for example, a ROM, in which a plurality of known symbol patterns are stored. As known symbols, pieces of K-ary (K is an integer greater than one) Phase Shift Keying (PSK)-modulated known information are transmitted on several of a plurality of OFDM subcarriers allocated in advance. A known symbol pattern is a pattern indicating a subcarrier, of the plurality of subcarriers, on which the information value (known information) of a known symbol is transmitted. The known symbol pattern generator 15 stores a plurality of known symbol patterns with different subcarrier arrangements (the arrangements of subcarriers, of the plurality of subcarriers, on which known information is transmitted) for the transmission of known information.

When known symbols are transmitted, the plurality of known symbol patterns stored in the ROM of the known symbol pattern generator 15 are sequentially read out at the timings of the transmission of the known symbols in accordance with signals from a counter 16. The counter 16 is used for time measurement, and outputs its count value which changes with time. The readout known symbol patterns are input to a phase control unit 18 through a selector 17.

The phase control unit 18 rotates the phase of each subcarrier of the known symbol transmitted last by φ radians on the basis of the count value input from the counter 16, and outputs the known symbol patterns to the IFFT units 19-1 to 19-M.

When K-ary PSK-modulated information is superimposed on each of the subcarriers of known symbol, the phase rotation amount of the known symbol transmitted last is given by φ=π/K. With regard to known symbols except for the known symbol transmitted last (known symbols transmitted before the known symbol transmitted last), the known symbol patterns input from the selector 17 bypass the phase control unit 18 and are output to the IFFT units 19-1 to 19-M. The known symbols input from the IFFT units 19-1 to 19-M are converted into wave forms in the time domain and guided to the transmitting unit 20.

A plurality of known symbols are temporally continuously transmitted per antenna. The selector 17 distributes the known symbol patterns read out from the ROM of the known symbol pattern generator 15 in accordance with the transmission timings of the plurality of known symbols transmitted continuously so as to transmit them from proper transmitting antennas. The selector 17 distributes the known symbol patterns to the transmitting antennas 21-1 to 21-M in accordance with count values indicating time information which are output from the counter 16. If there are a plurality of known symbols like short and long preambles contained in a preamble of a wireless LAN, the counter 16 and selector 17 switch and read out a plurality of types of known symbol patterns from the ROM.

The selector 17 stores in advance a table like that shown in FIG. 7, which indicates what kinds of patterns (known symbol patterns) the known symbols transmitted from the respective antennas have. The selector 17 distributes, on the basis of this table, the known symbol patterns read out from the known symbol pattern generator 15 so as to transmit them from proper transmitting antennas. Note that, for the sake of descriptive convenience, FIG. 7 shows the transmitting antennas 21-1 to 21-M in FIG. 1 as antennas 1 to M.

Referring to FIG. 7, with regard to known symbols transmitted from antenna 1, antenna 2, . . . , antenna M-1, and antenna M, e.g., symbol 1, pattern 1, pattern 2, . . . , pattern M-1, and pattern M are transmitted from the respective antennas. With regard to symbol 2, the assignment of patterns for the known symbols to be transmitted as symbols is shifted by one pattern, so that pattern 2, pattern 3, . . . , pattern M, and pattern 1 are transmitted from the respective antennas. Subsequently, in the same manner, with regard to symbol M, pattern M, pattern 1, . . . , pattern M-1 are transmitted as known symbols from the respective antennas.

On the other hand, upon receiving M known symbols simultaneously transmitted from the respective transmitting antennas, the receiver to be described later can estimate channel estimation values and the number of transmitting antennas corresponding to all the subcarriers.

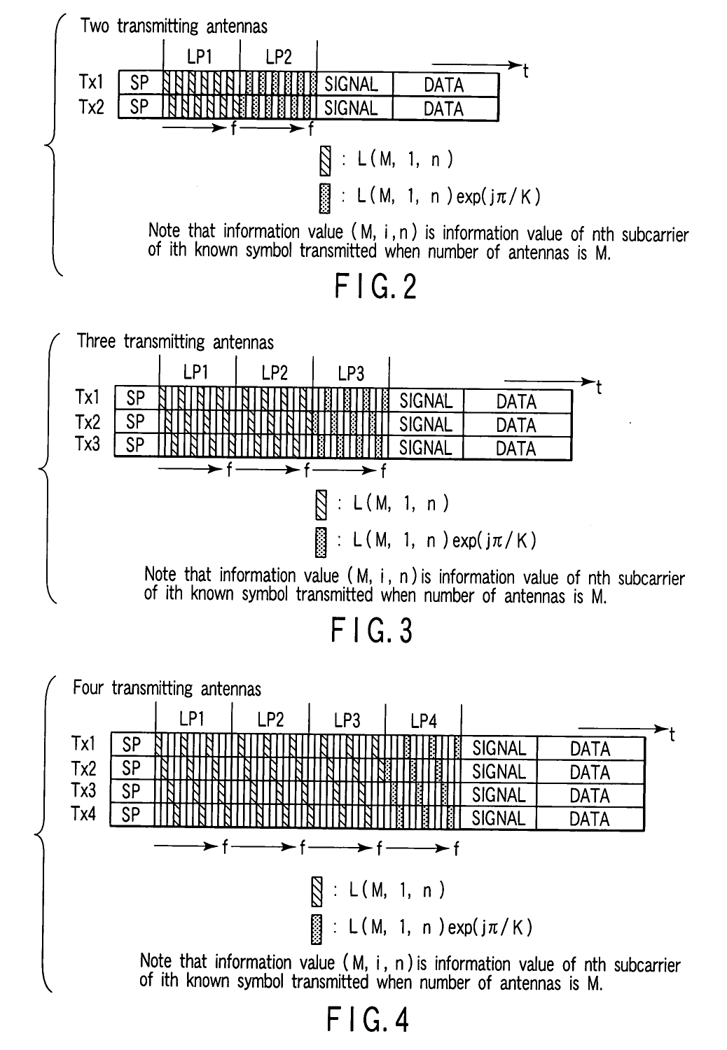

An example of a method of transmitting known symbols for channel estimation will be described in detail next with reference to FIGS. 2 to 4. FIGS. 2 to 4 respectively show the structures of wireless frames containing preambles in cases wherein the number of antennas from which known symbols are simultaneously transmitted is “2”, “3”, and “4”.

This embodiment assumes a system designed to transmit a short preamble SP for synchronization and a long preamble LP for channel estimation before the transmission of a data field (DATA) as in a wireless LAN. In this case, the arrangement of the short preamble SP is not specifically limited. For example, a short preamble like that defined in IEEE 802.11a may be transmitted from a plurality of transmitting antennas.

A known symbol is used for channel response estimation at the time of MIMO communication and corresponds to the long preamble LP in FIGS. 2 to 4 in a wireless LAN. Referring to FIGS. 2 to 4, the long preambles LP to be transmitted from the respective transmitting antennas are frequency-division-multiplexed.

Assume that if the number of transmitting antennas and the number of OFDM subcarriers are represented by M and N, respectively, and N can be divided by M without any remainder, known symbol information exists in the subcarriers (with the numbers of N subcarriers being defined as 0th to (N−1)th) represented by equation (1) but does not exist in the remaining subcarriers:
(Mk+m+i−2) mod N (1)

Assume that m=1, 2, . . . , M represents an antenna number, i=1, 2, . . . , which represents the number of a known symbol in the time direction, k=0, 1, . . . , (N/M−1), and known information is K-ary PSK-modulated. Thus the number of states included in one symbol (the modulation-level) is represented by K.

An information value L(M,i,n) transmitted on the nth subcarrier of the ith known symbol when the number of antennas is represented by M is expressed by equations (2), (3), and (4):
L(M,i,n)=exp (2πjp/K) (2)
If i≠M, then L(M,i,n)=L(M,1,n) (3)
If i=M, then
L[M, M(n)]=L(M,1,n)exp(jπ/K) (4)
Where j is an imaginary unit, and p is one of the numbers {0, 1, . . . , K−1}. As indicated by equations (2), (3), and (4), the information on each subcarrier of each known symbol is K-ary PSK-modulated information. With regard to the known symbol (the Mth known symbol at the termination) to be transmitted at the last time, the phase of the information value is rotated by π/K radians in accordance with the modulation-level K (equivalent to multiplying exp(jπ/K)).

If, for example, the information value on each subcarrier of a known symbol is two-ary (K=2) PSK—modulated information, the phase rotation amount of the last symbol becomes n/2 radians, which is equivalent to multiplying exp(jπ/2)=j (j is an imaginary unit) (i.e., the information value transmitted with the Mth known symbol can be represented by jL(M,1,n)). According to equations (1) to (4), the following are the combinations (known symbol patterns) of information values on the 0th to 11th subcarriers of two known symbols to be transmitted from antennas 1 and 2 (two antennas: M=2) in FIG. 2, For the sake of descriptive convenience, the transmitting antennas 21-1 to 21-M in FIG. 1 are shown as antennas 1 to M.
antenna 1: first known symbol: {L(2, 1, 0), 0, L(2, 1, 2), 0, L(2, 1, 4), 0, L(2, 1, 6), 0, L(2, 1, 8), 0, L(2, 1, 10), 0}
antenna 1: second known symbol: {0, jL(2, 1, 1), 0, jL(2, 1, 3), 0, jL(2, 1, 5), 0, jL(2, 1, 7), 0, jL (2, 1, 9), 0, jL (2, 1, 11)}
antenna 2: first known symbol: {0, L(2, 1, 1), 0, L(2, 1, 3), 0, L(2, 1, 5), 0, L(2, 1, 7), 0, L(2, 1, 9), 0, L(2, 1, 11)}
antenna 2: second known symbol: {jL(2, 1, 0), 0, jL(2, 1, 2), 0, jL(2, 1, 4), 0, jL(2, 1, 6), 0, jL(2, 1, 8), 0, jL(2, 1, 10), 0}

When the number of antennas is 2, subcarriers carrying known information are adjacent to each other between two known symbols temporally continuously transmitted from respective antennas, and subcarriers carrying known information differ from each other between known symbols simultaneously transmitted from different antennas. The phase of the second known symbol transmitted from each antenna is rotated by π/2 radians.

In the case shown in FIG. 3 (three antenna: M=3), according to equations (1) to (4), the following are the combinations (known symbol patterns) of information values on the 0th to 11th subcarriers of three known symbols to be transmitted from antennas 1, 2, and 3.
antenna 1: first known symbol: {L(3, 1, 0), 0, 0, L(3, 1, 3), 0, 0, L(3, 1, 6), 0, 0, L(3, 1, 9), 0, 0}
antenna 1: second known symbol: {0, L(3, 1, 1), 0, 0, L(3, 1, 4), 0, 0, L(3, 1, 7), 0, 0, L(3, 1, 10), 0}
antenna 1: third known symbol: {0, 0, jL(3, 1, 2), 0, 0, jL(3, 1, 5), 0, 0, jL(3, 1, 8), 0, 0, jL(3, 1, 11)}
antenna 2: first known symbol: {0, L(3, 1, 1), 0, 0, L(3, 1, 4), 0, 0, L(3, 1, 7), 0, 0, L(3, 1, 10), 0}
antenna 2: second known symbol: {0, 0, L(3, 1, 2), 0, 0, L(3, 1, 5), 0, 0, L(3, 1, 8), 0, 0, L(3, 1, 11)}
antenna 2: third known symbol: {jL(3, 1, 0), 0, 0, jL(3, 1, 3), 0, 0, jL(3, 1, 6), 0, 0, j(L3, 1, 9), 0, 0}
antenna 3: first known symbol: {0, 0, L(3, 1, 2), 0, 0, L(3, 1, 5), 0, 0, L(3, 1, 8), 0, 0, L(3, 1, 11)}
antenna 3: second known symbol: {L(3, 1, 0), 0, 0, L(3, 1, 3), 0, 0, L(3, 1, 6), 0, 0, L(3, 1, 9), 0, 0}
antenna 3: third known symbol: {0, jL(3, 1, 1), 0, 0, jL(3, 1, 4), 0, 0, jL(3, 1, 7), 0, 0, jL(3, 1, 10), 0}

When the number of antennas is 3, subcarriers carrying known information are adjacent to each other between two known symbols temporally continuously transmitted from the respective antennas, and subcarriers carrying known information differ from each other between known symbols simultaneously transmitted from different antennas. The phase of the third known symbol transmitted from each antenna is rotated by π/2 radians.

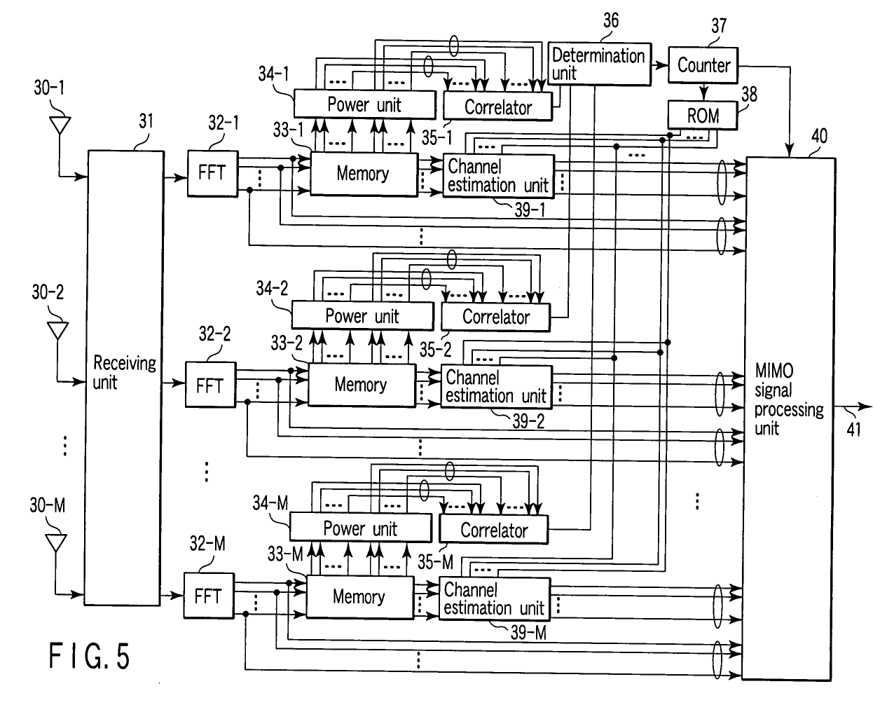

When the number of antennas is 4 or more as well, combinations (known symbol patterns) of information values on the 0th to 11th subcarriers of known symbols transmitted from the respective antennas are obvious from the above analogy. When the number of antennas is 4 (see FIG. 4), subcarriers carrying known information are adjacent to each other between two known symbols temporally continuously transmitted from the respective antennas, and subcarriers carrying known information differ from each other between known symbols simultaneously transmitted from different antennas. The phase of the fourth known symbol transmitted from each antenna is rotated by π/2 radians.

Referring to FIGS. 2 to 4, the structure of a preamble is expressed in the time domain. For the sake of convenience, with regard to the long preambles LP, subcarriers on which known information carried are expressed by oblique lines and dots. Each subcarrier expressed by dots in FIGS. 2 to 4 represents a subcarrier on which the known information obtained by rotating the phase according to equation (4) is carried.

As shown in FIGS. 2 to 4, each known symbol according to this embodiment is characterized in that the phase of the known symbol transmitted last is rotated in accordance with the modulation-level of known information which is PSK-modulated and carried on each subcarrier.

The receiver according to this embodiment of the present invention will be described next with reference to FIG. 5. Referring to FIG. 5, OFDM signals in the RF (Radio Frequency) band transmitted from the transmitter in FIG. 1 are received by a plurality of receiving antennas 30-1 to 30-M. The OFDM reception signals from the receiving antennas 30-1 to 30-M are input to a receiving unit 31.

In the receiving unit 31, the OFDM signals input from the receiving antennas 30-1 to 30-M are respectively amplified by low-noise amplifiers (LNAs), and the amplified signals are frequency-converted (down-converted) into baseband signals by frequency converters. The resultant signals are converted into digital signals by analog to digital (A/D) converters. In addition, guard intervals (GIs) are removed from the digital signals.

Output signals from the receiving unit 31 are input to fast Fourier transform (FFT) units 32-1 to 32-M. As a consequence, the signals having wave forms in the time domain are converted into signals having wave forms in the frequency domain, that is, into wave forms for each subcarrier. Of the output signals from the FFT units 32-1 to 32-M, signals in the data symbol intervals are input to the MIMO signal processing unit 40.

Of the output signals from the FFT units 32-1 to 32-M, signals for the respective subcarriers in the preamble intervals, especially the known symbol intervals, are sequentially stored in memories 33-1 to 33-M. When the ith known symbol (i≧2) is stored in the memories 33-1 to 33-M, a signal for each subcarrier of the ith known symbol stored in the memories 33-1 to 33-M and a signal for each subcarrier of the (i−1)th known symbol are input to power units 34-1 to 34-M, respectively.

If information carried on each subcarrier of each known symbol is K-ary PSK-modulated information, the power units raise the signals on the respective subcarriers input from the memories 33-1 to 33-M to the Kth power, and output the resultant signals to correlators 35-1 to 35-M, respectively. The correlators 35-1 to 35-M calculate a correlation value between the Kth power of the ith known symbol and the Kth power of the (i-1)th known symbol, and input the correlation value to a determination unit 36.

If the determination unit 36 determines that the input correlation value is positive, the next known symbol is received and a counter 37 is incremented. If the determination unit 36 determines that the input correlation value is negative, the unit outputs the current counter value of the counter 37 as the estimated value of the number of transmitting antennas to a ROM 38 and MIMO signal processing unit 40. The above algorithm for estimating the number of transmitting antennas will be described in detail later.

Known symbol patterns in the frequency domain are stored in the ROM 38, and known symbol patterns corresponding to the estimated numbers of transmitting antennas are output to channel estimation units 39-1 to 39-M, respectively. The channel estimation units 39-1 to 39-M divide the received known symbols stored in the memories 33-1 to 33-M by the known symbol patterns read out from the ROM 38 to estimate channel characteristics, and output them to the MIMO signal processing unit 40.

The MIMO signal processing unit 40 performs MIMO signal reception processing like maximum likelihood estimation with respect to the signals in the data symbol intervals from the FFT units 32-1 to 32-M in accordance with the channel characteristic estimation values (channel estimation values) from the channel estimation units 39-1 to 39-M and the estimated value of the number of transmitting antennas from the counter 37. The signals having undergone the MIMO signal reception signal processing are channel-decoded. Data 41 transmitted after the above processing is reproduced.

In this case, let X(m, i, n) be the nth subcarrier signal of the ith known symbol received by the mth receiving antenna. The Kth power of the subcarrier signal X(m, i, n) is output signal from each of the power units 34-1 to 34-M, and expressed as A(m, i, n). The Kth power A(m, i, n) of the subcarrier signal X(m, i, n) is given by equation (5):
A(m,I,n)=X(m,I,n)**K (5)
where “**” represents the exponential operator. Letting h(m, i, n) be the actual channel characteristic value of this subcarrier, and N(m, i, n) be a noise signal, X(m, i, n) can be given by
X(m, i,n)=h(m,i,n)·L(M,i,n)+N(m, i,n) (6)
Therefore, equation (5) can be expressed by equation (7) given below:
A(m,i,n)={h(m,i,n)·L(M,i,n)+N(m, i,n)}**K (7)
For the sake of descriptive convenience, if an ideal environment (Nm (i, n)=0) where no noise is added is assumed, equation (7) can be expressed by equation (8) given below:
A(m, i,n)={h(m, i,n)**K}·{L(M,i,n)**K} (8)

In this case, if L(M,i,n)**K is given as follows, according to equations (2), (3), and (4):

If i≠M, then
L(M,i,n)**K=L(M,1,n)**K=1 (9)

If i=M, then

$$\begin{matrix}L ( M , i , n ) ** K = \{ L ( M , 1 , n ) exp ( j Π / K ) \} ** K \\ = \{ L ( M , 1 , n ) ** K \} \cdot \{ exp ( j Π / K ) ** K \} \\ = - 1\end{matrix} \qquad ( 10 )$$

Therefore, equation (8) can be simplified into equations (11) and (12) given below:
If i≠M, then A(m, i,n)=h(m, i,n)**K (11)
If i=M, then A(m, M,n)=−h(m, M,n)**K (12)

Assuming that the channel influences on adjacent subcarriers transmitted from the same antenna are almost the same, i.e., the channel characteristics of the adjacent subcarriers transmitted from the same antenna exhibit similar values, it is expected that the following values A(m, i, n) are obtained with respect to all the receiving antennas.

<With Two Transmitting Antennas (M=2)>

With regard to the known symbol (i=1) received first, A(m, 1, n)=h(m, 1, n)**K is obtained for the nth subcarrier according to equation (11). With regard to the known symbol (i=2) received second, A(m, 2, n+1)=−h(m, 2, n+1)**K is obtained for the (n+1)th subcarrier according to equation (12).

Since the nth subcarrier of the known symbol (i=1) received first and the (n+1)th subcarrier of the known symbol (i=2) received second are transmitted from the same antenna, the values of channel characteristics h(m, 1, n) and h(m, 2, n+1) are similar to each other, and A(m, 1, n) and A(m, 2, n+1) have a high correlation. However, since the phase of A(m, 2, n+1) is inverted with respect to that of A(m, 1, n), they have a high negative correlation value.

<With Three Transmitting Antennas (M=3)>

With regard to the known symbol (i=1) received first, A(m, 1, n)=h(m, 1, n)**K is obtained for the nth subcarrier according to equation (11). With regard to the known symbol (i=2) received second, A(m, 2, n+1)=h(m, 2, n+1)**K is obtained for the (n+1)th subcarrier according to equation (11). With regard to the known symbol (i=3) received third, A(m, 3, n+2)=−h(m, 3, n+2)**K is obtained for the (n+2)th subcarrier according to equation (12).

Since the nth subcarrier of the known symbol (i=1) received first and the (n+1)th subcarrier of the known symbol (i=2) received second are transmitted from the same antenna, the values of channel characteristics h(m, 1, n) and h(m, 2, n+1) are similar to each other, and A(m, 1, n) and A(m, 2, n+1) have a high positive correlation. Since the (n+1)th subcarrier of the known symbol (i=2) received second and the (n+2)th subcarrier of the known symbol (i=3) received third are transmitted from the same antenna, the values of channel characteristics h(m, 2, n+1) and h(m, 3, n+2) are similar to each other, and A(m, 2, n+1) and A(m, 3, n+2) have a high positive correlation. However, since the phase of A(m, 3, n+2) is inverted with respect to that of A(m, 2, n+1), they have a high negative correlation value.

<With Fourth Transmitting Antennas (M=4)>

With regard to the known symbol (i=1) received first, A(m, 1, n)=h(m, 1, n)**K is obtained for the nth subcarrier according to equation (11). With regard to the known symbol (i=2) received second, A(m, 2, n+1)=h(m, 2, n+1)**K is obtained for the (n+1)th subcarrier according to equation (11). With regard to the known symbol (i=3) received third, A(m, 3, n+2)=h(m, 3, n+2)**K is obtained for the (n+2)th subcarrier according to equation (11). With regard to the known symbol (i=4) received fourth, A(m, 4, n+3)=−h(m, 4, n+3)**K is obtained for the (n+3)th subcarrier according to equation (12).

Since the nth subcarrier of the known symbol (i=1) received first and the (n+1)th subcarrier of the known symbol (i=2) received second are transmitted from the same antenna, the values of channel characteristics h(m, 1, n) and h(m, 2, n+1) are similar to each other, and A(m, 1, n) and A(m, 2, n+1) have a high positive correlation. Since the (n+1)th subcarrier of the known symbol (i=2) received second and the (n+2)th subcarrier of the known symbol (i=3) received third are transmitted from the same antenna, the values of channel characteristics h(m, 2, n+1) and h(m, 3, n+2) are similar to each other, and A(m, 2, n+1) and A(m, 3, n+2) have a high positive correlation. Since the (n+2)th subcarrier of the known symbol (i=3) received third and the (n+3)th subcarrier of the known symbol (i=4) received fourth are transmitted from the same antenna, the values of channel characteristics h(m, 3, n+2) and h(m, 4, n+3) are similar to each other, and A(m, 3, n+2) and A(m, 4, n+3) have a high positive correlation. However, since the phase of A(m, 4, n+3) is inverted with respect to that of A(m, 3, n+2), they have a high negative correlation value.

As is obvious from the above description, if the number of transmitting antennas is M, since the Kth power signal of the Mth received symbol and the Kth power signal of the (M−1)th received symbol in the receiver have a high negative correlation value, it can be expected at this point of time that the number of antennas is M.

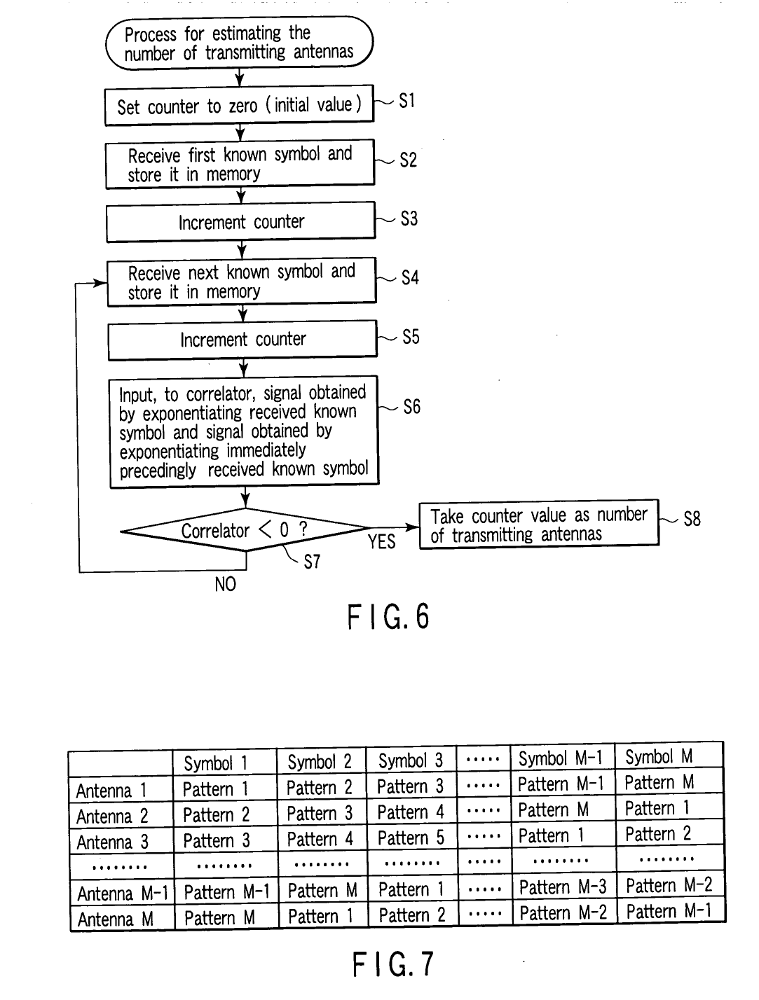

An algorithm for a process for estimating the number of transmitting antennas in the receiver in FIG. 5 will be described below with reference to the flowchart of FIG. 6. First of all, “0” is set as an initial value in the counter 37 (step S1). The known symbol received first by the mth antenna is then input to the memory 33-m, and the counter 37 is incremented by one (steps S2 and S3).

The known symbol received next is stored in the memory 33-m, and the counter 37 is incremented by one (steps S4 and S5). Thereafter, of the received known symbols stored in the memory 33-m, the currently stored known symbol (the ith known symbol) and the known symbol (the (i−1)th known symbol) stored immediately preceding the currently stored known symbol (before one symbol) are output to the power unit 34-m, which in turn raises the ith known symbol and (i−1)th known symbol to the Kth power in accordance with a modulation-level K of PSK-modulated known information carried on each subcarrier. The resultant signals A(m, i, n) and A(m, i−1, n) are input to the correlator 35-m (step S6).

The correlator 35-m obtains the correlation value between the Kth power of the ith known symbol, i.e., the signal A(m, i, n), and the Kth power of the (i−1)th known symbol, i.e., the signal A(m, i−1, n). This correlation computation is defined as follows at the time of the reception of the ith known symbol:
(correlation value)=A(m, i−1, 0)*A(m, i,1)+A(m, i−l 1, 1)*A(m, ,2)+A(m, i−l 1, 2)*A(m, ,3)+ . . . +A(m, i−1, N−2)*A(m, i, N−1)
   where a*b is an operator for multiplying “a” by the complex conjugate of “b”.

If the correlation value calculated by the correlator 35-m is a negative value (step S7), the determination unit 36 determines that the currently received symbol is the last known symbol. The number of transmitting antennas is then estimated on the basis of the number of known symbols received so far which are counted by the counter 37 (step S8). In this case, since the number of known symbols is equal to the number of transmitting antennas, the value of the counter 37 becomes the estimated value of the number of transmitting antennas.

The MIMO signal processing unit 40 reproduces a data symbol by using the number of transmitting antennas estimated in the manner shown in FIG. 6. If it is determined in step S7 that the above correlation value is not a negative value, the flow returns to step S4 to receive the next known symbol (step S4). Subsequently, every time a new known symbol is received, the operation in steps S5 to S7 is repeated.

If there are a plurality of receiving antennas, the following schemes are also conceivable.

(a) Only when all the receiving antennas exhibit negative correlation values, the known symbol sequence is regarded as terminated, and the number of transmitting antennas is determined.

(b) If the sum of correlation values calculated from all the receiving antennas becomes a negative value, the known symbol sequence is regarded as terminated, and the number of transmitting antennas is determined.

The condition for scheme (a) described above is stricter than the other, but scheme (a) can accurately detect the number of transmitting antennas when the condition is met.

As described above, according to the above embodiment, the transmitter transmits a plurality of known symbol sequences by using a plurality of antennas, each of the known symbol sequences including a plurality of known symbols, the known symbol whose plural known information being carried on a plurality of subcarriers, the known information being modulated by using a modulation scheme with the modulation-level K (e.g., K-ary PSK), the phase of one of the known symbols which is transmitted last being rotated by a phase rotation amount [π/K radians] determined in accordance with the modulation-level K.

Upon transmitting the known symbol sequences, the transmitter transmits data symbols by using the antennas.

As shown in FIGS. 2 to 4, with regard to the respective known symbols of known symbol sequences, the positions of subcarriers on which known information are carried are adjacent to each other between temporally adjacent known symbols.

In addition, with regard to a plurality of known symbol sequences, as shown in FIGS. 2 to 4, the positions of subcarriers on which known information are carried differ from each other between known symbols simultaneously transmitted from different antennas.

The receiver receives a plurality of known symbol sequences and data symbols after the known symbol sequences transmitted from the transmitter. The receiver obtains a channel estimation value from the received known symbol sequences, and raises the two temporally adjacent known symbols of the received known symbol sequences to the Kth power, thereby obtaining the correlation value between the signals obtained by raising the two known symbols to the Kth power. If a negative correlation value is obtained, the number of antennas on the transmitting side is estimated on the basis of the number of known symbols received.

As described above, according to the above embodiment, when a terminal known symbol whose phase is rotated is detected from the correlation value between two temporally adjacent known symbols on the receiving side, the number of antennas on the transmitting side is estimated on the basis of the total number of known symbols received until the reception of the terminal known symbol, including the terminal known symbol. This makes it possible to estimate the number of transmitting antennas while performing channel estimation for each antenna by using known symbols without notifying the number of transmitting antennas from the transmitting side.

What is claimed is:

1. A wireless communication apparatus comprising:
a plurality of antennas for transmitting a plurality of known symbol sequences and data symbols;
a first transmitting unit configured to transmit the known symbol sequences, each of the known symbol sequences including a plurality of known symbols, each of the known symbols whose plural known information being carried on a plurality of subcarriers, a phase of last known symbol of the each of the known symbol sequences being rotated; and
a second transmitting unit configured to transmit the data symbols after the known symbol sequences are transmitted.

2. The apparatus according to claim 1, wherein the plural known information are K-ary (K is an integer not less than two) phase shift keying (PSK)-modulated information, and a phase of the last known symbol is rotated by n/K radians.

3. The apparatus according to claim 1, wherein the plural known information of the each of the known symbols included in the each of the known symbol sequences are carried on different subcarriers.

4. The apparatus according to claim 1, wherein subcarriers on which the plural known information carried are adjacent to each other between temporally adjacent known symbols included in the each of the known symbol sequences.

5. The apparatus according to claim 1, wherein subcarriers on which the plural known information carried differ from each other between known symbols simultaneously transmitted from different antennas.

6. The apparatus according to claim 1, wherein the first transmitting unit includes:
memory to store a plurality of known symbol patterns having different subcarrier arrangements on which the plural known information are carried;
timing generating unit configured to generate a timing signal indicating a timing at which the known symbol is transmitted;
selector to select a known symbol pattern to be used in the known symbol from the known symbol patterns stored in the memory in accordance with the timing signal.

7. A wireless communication apparatus comprising:
a first receiving unit configured to receive each of a plurality of known symbols included in each of known symbol sequences which are transmitted by a plurality of antennas of a transmitter, the each of the known symbols whose plural known information being carried on a plurality of subcarriers, a phase of last known symbols of the each of the known symbol sequences being rotated;
a second receiving unit configured to receive data symbols after the known symbol sequences;
a first calculating unit configured to calculate a channel estimation value from each of the known symbol received;
a counter to count the number of known symbols received;
a second calculating unit configured to calculate a correlation value between two temporally adjacent known symbols received;
a estimating unit configured to estimate the number of antennas based on the correlation value and the value of the counter; and
a unit configured to reproduce the data symbols by using the channel estimation value and the estimated number of antennas.

8. The apparatus according to claim 7, wherein the plural known information are K-ary (K is an integer not less than two) phase shift keying(PSK)-modulated information, and
the second calculating unit raises each of the two temporally adjacent known symbols to Kth power and calculate the correlation value between the two temporally adjacent known symbols which are raised to the Kth power.

9. The apparatus according to claim 7, wherein the estimating unit estimates the number of antennas based on the value of the counter when a negative value is calculated as the correlation value.

10. A wireless communication apparatus comprising:
a plurality of antennas for transmitting a plurality of known symbol sequences and data symbols;
a first transmitting unit configured to transmit the known symbol sequences, each of the known symbol sequences including a plurality of known symbols, each of the known symbols whose plural known information being K-ary (K is an integer not less than two) phase shift keying (PSK)-modulated information and being carried on a plurality of subcarriers, and a phase of last known symbol of the each of the known symbol sequences being rotated by π/K radians; and
a second transmitting unit configured to transmit the data symbols after the known symbol sequences are transmitted.

11. A method for estimating the number of antennas of a transmitter which transmits a plurality of known symbol sequences, each of the known symbol sequences including a plurality of known symbols, each of the known symbols whose plural known information being K-phase (K is an integer not less than two)-modulated information and being carried on a plurality of subcarriers, and a phase of last known symbol of the each of the known symbol sequences being rotated by a phase rotation amount which is determined by the K; and transmits data symbols, the method applied to a receiver, comprising:
receiving the each of the known symbols included in the each of the known symbol sequences;
counting the number of known symbols received;
raising each of two temporally adjacent known symbols received to Kth power;
calculate a correlation value between the two temporally adjacent known symbols which are raised to the Kth power;
estimating the number of antennas based on the value of the counter when a negative value is calculated as the correlation value.
